(19) United States
(12) Patent Application Publication
(10) Pub. No.: US 2024/0281337 A1
(43) Pub. Date: Aug. 22, 2024

(54) METHOD AND COMPUTER PROGRAM FOR AUTOMATICALLY COMPRESSING BACKUP DATA ON BASIS OF CREATED LIST

(71) Applicant: ELLUX CO., LTD., Jeollanam-do (KR)

(72) Inventors: PIL SUK KIM, Gyeonggi-do (KR); TAE SUP KIM, Gyeonggi-do (KR)

(21) Appl. No.: 18/567,898

(22) PCT Filed: Jun. 7, 2022
(86) PCT No.: PCT/KR2022/008010

§ 371 Date: Dec. 7, 2023

(30) Foreign Application Priority Data
Jun. 11, 2021 (KR) 10-2021-0075858

(51) Int. Cl. G06F 11/14; G06F 16/11; G06F 16/174

(52) U.S. Cl. CPC G06F 11/1448; G06F 16/113; G06F 16/1744; G06F 2201/84

(57) ABSTRACT

In a method of automatically compressing backup data on the basis of a created list, property information of objects to be compressed and compression information from a user are received, and a list is created. compression objects corresponding to the compression object conditions input in the list are searched and extracted. The extracted compression objects are compressed on the basis of the compression information input in the list.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/008010, filed Jun. 7, 2022, which claims priority to the benefit of Korean Patent Application No. 10-2021-0075858 filed in the Korean Intellectual Property Office on Jun. 11, 2021, the entire contents of which are incorporated herein by reference.

### BACKGROUND

### 1. Technical Field

The present disclosure relates to a method and computer program for automatically compressing backup data on the basis of a created list. In more detail, the present disclosure relates to a method and computer program for automatically compressing backup data on the basis of a created list, the method and computer program being able to perform backup by automatically extracting and compressing compression objects on the basis of a list including property information, compression information, etc. of the objects to be compressed.

### 2. Background Art

In general, when data in the computers of agencies, companies, individuals, etc. are lost due to disorders of the computer system, mistakes of users, etc., system or data backup is fundamentally performed to minimize a vacuum or paralysis that is generated due to data loss or damage.

Data backup in this case means copying data information created and processed in the computer of the user into a specific backup space.

Such data backup is achieved by receiving original data from the user and storing the original data into the backup area or by installing a system having a specific backup space and backing up data thereto.

Further, data backup is performed every predetermined period or in accordance with a request from a user.

However, as various types of computer processing are performed, the amount of data that have to be backed up increases and the space for storing and keeping backup data becomes short, compression of backup data was performed.

Data compression is a technique of reducing the size of data to efficiently store data in a smaller storage space or decrease a data transmission time.

Accordingly, in order to compress files or directories to be backed up in the related art, users individually selected object to be compressed and then input the objects into a compression program or integrated compression object in one folder and then compressed them.

However, as the data to be backed up increase, the work time for users to integrate data increases and data may be missed or repeated due to mistakes of users. Further, since users have to participate in the same backup compression work at designated periods, there is a problem that work efficiency decreases.

Accordingly, there is a need for a method of automatically compressing backup data that can improve work efficiency by enabling a user to simply and quickly manage backup work that takes a long time without missing or repeating of data due to mistakes of the user when compressing a large quantity of data to be backed up.

### SUMMARY

The present disclosure has been made in an effort to solve the problems described above and an objective of the present disclosure is to provide a method and computer program for automatically compressing backup data on the basis of a created list, the method being able to quickly and simply perform same repeated work without repeating or missing of data due to mistakes of a human and accordingly improve work efficiency because it is possible to automatically extract and compress compression objects on the basis of specific information of the objects, which a user wants to compress, even though the user individually selects and integrates a large amount of backup data to be compressed.

In order to achieve the objectives described above, the present disclosure includes: a first step of receiving property information of objects to be compressed (hereafter, referred to as ‘compression object conditions’) and compression information from a user, and creating a list; a second step of searching for and extracting compression objects corresponding to the compression object conditions input in the list; and a third step of compressing the extracted compression objects on the basis of the compression information input in the list.

In an exemplary embodiment, the compression object conditions may include information on specific characters or specific extensions of the compression objects, information on a specific directory to be compressed, and information on a directory designated to search for compression objects (hereafter, referred to as a ‘search range’).

In an exemplary embodiment, the compression information may include automatic compression period information, compressed file creation location information, and compression format information.

In an exemplary embodiment, in the first step, the list may be received from a user directly in real time or a list file separately created by the user may be received.

In an exemplary embodiment, the second step may include: creating an archive file for temporarily storing the compression objects; and extracting and recording compression objects, which correspond to the compression object conditions in a directory corresponding to the search range, in the archive file; and the third step may compress the archive file having the compression objects recorded when all of directories corresponding to the search range finish being searched.

In an exemplary embodiment, the list may be created by further receiving type information that can be classified as a white list and a black list, and the second step may extract and record objects, which correspond to the compression object conditions, in the archive file when the list is a white list, and may extract and record objects, which do not correspond to the compression object conditions, in the archive file when the list is a black list.

Further, the present disclosure further provides a computer program wherein the method of automatically compressing backup data on the basis of a created list is recorded in a recording medium.

The present disclosure has the following excellent effects.

According to the method and computer program for automatically compressing backup data on the basis of a created list of the present disclosure, since it is possible to search data on the basis of a list created by receiving property information of backup data to be compressed from a user and to automatically extract and compress corresponding data, it is possible to easily and conveniently compress and manage data to be backed up at designated periods without missing or repeating of data due to mistakes of a human, so there is the advantage that it is possible to improve work efficiency.

The effects of the present disclosure are not limited to the effects described above and other effects can be clearly understood by those skilled in the art from the following description.

### BRIEF DESCRIPTION OF THE DRAWINGS

FIG. 1 is a first flowchart of a method of automatically compressing backup data on the basis of a created list according to an embodiment of the present disclosure.

FIG. 2 is a second flowchart of the method of automatically compressing backup data on the basis of a created list according to an embodiment of the present disclosure.

### DETAILED DESCRIPTION

Terminologies that are generally used at present were selected and used in the present disclosure, but some specific terminologies were freely selected by the applicant (s), and in this case, the meanings of the specific terminologies should be construed in consideration of not simply the names of the terminologies, but the meanings that are described or used in the detailed description of the present disclosure.

The technical configuration of the present disclosure will be described hereafter in detail with reference to exemplary embodiments shown in the accompanying drawings.

However, the present disclosure is not limited to the embodiments described herein and may be implemented in other ways. Like reference numerals indicate the same components throughout the specification.

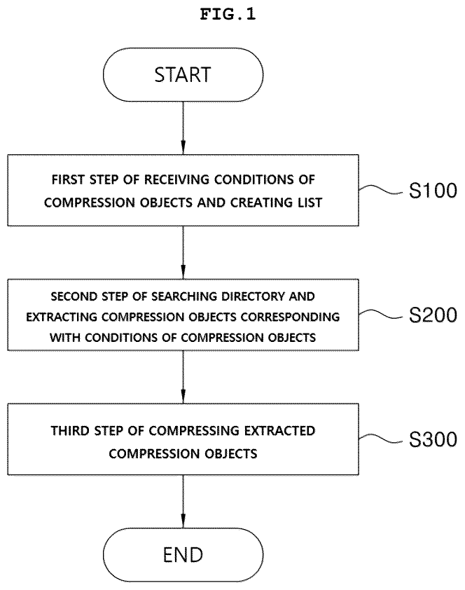

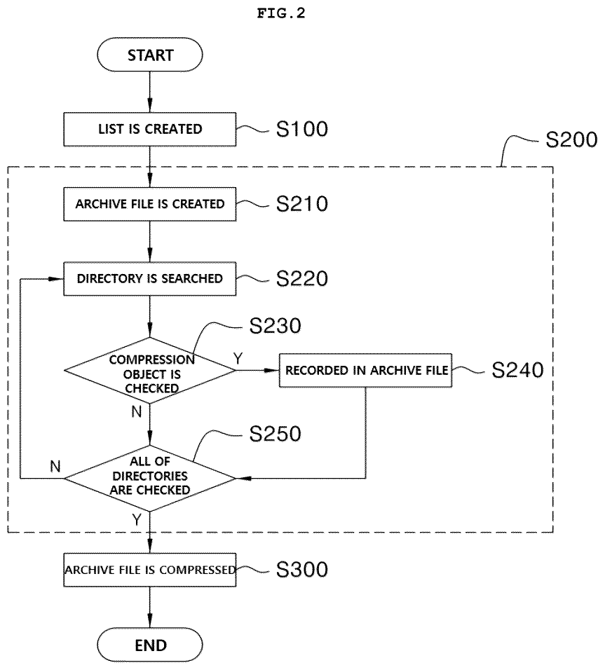

FIG. 1 is a first flowchart of a method of automatically compressing backup data on the basis of a created list according to an embodiment of the present disclosure and FIG. 2 is a second flowchart of the method of automatically compressing backup data on the basis of a created list according to an embodiment of the present disclosure.

Referring to FIGS. 1 and 2, the method and computer program for automatically compressing backup data on the basis of a created list of the present disclosure relates to a method that can automatically extract and compress compression objects on the basis of a created list including property information, compression information, etc. of the objects that a user wants to compress.

Further, the method of automatically compressing backup data on the basis of a created list of the present disclosure is performed by a computer and a computer program for performing the method by operating the computer is stored in the computer.

Further, the computer is a computer in a broad sense including not only a general personal computer, but also a server computer and a cloud system that can be accessed through a communication network, smart devices such as a smartphone and a tablet, and an embedded system.

Further, the computer program may be stored and provided in a specific recording medium and the recording medium may be a medium specifically designed and configured for the present disclosure or may be a medium well known to be usable to those skilled in the computer software field.

For example, the computer-readable medium may be a hardware device that is specifically configured to keep and perform program instructions independently or through combination such as a magnetic medium including a hard disc, a floppy disc, and a magnetic tape, an optical recording medium including a CD and a DVD, a magnetic-optical medium that can perform both of magnetic and optical recording, and a ROM, a RAM, and a flash memory.

Further, the computer program may be a program in which program instructions, local data files, and local data structures are independently provided or combined, and may be a program composed of not only machine language codes such as those made by a compiler, but high-level language codes that can be executed by a computer using an interpreter.

Hereafter, a method of automatically compressing backup data on the basis of a created list according to an embodiment of the present disclosure is described in detail.

The method of automatically compressing backup data on the basis of a created list according to an embodiment of the present disclosure, in a broad meaning, includes a first step of f receiving information of objects to be compressed and creating a list (S100); a second step of extracting compression objects corresponding to compression object conditions by searching a directory (S200); and a third step of compressing the extracted compression objects (S300).

In detail, the method of automatically compressing backup data on the basis of a created list of the present disclosure, first, receives feature information of objects to be compressed from a user and creates a list (S100).

Here, the feature information of objects to be compressed includes property information of the objects to be compressed (hereafter, referred to as a ‘compression object conditions’) and information required to perform compression (hereafter, referred to as ‘compression information’).

The conditions for sorting compression objects, which are inherent items of information of the respective objects to be compressed, are conditions for sorting the compression objects.

For example, the compression object conditions may be information on specific characters or specific extensions of the compression objects, information on a specific directory to be compressed, and information on a directory designated to search for compression objects (hereafter, referred to as a ‘search range’).

Here, the search range means searching even all of the lower directories included in an upper directory.

The compression information, which is information for compressing extracted compression objects, includes automatic compression period information, compressed file creation location information, compression format information, etc.

In detail, the compression information may be automatic compression period information set to automatically perform compression at every backup period, compressed file creation location information having the address where a file created through compression is to be stored, and compression format information showing the architecture of the created compressed file when the file is stored.

Here, the compression format information may have an extension such as .zip, .apk, .rar, .7z, and .tart.

Meanwhile, the list provides compression object condition that may be received from a user and various items of the compression information, and may additionally provide items of compression object information that a user wants.

The list may provide all of the items of feature information stated above or may be selectively input, depending on necessity of a user.

The list may be created by receiving the compression object conditions and compression information directly from a user, but it is also possible to receive a list file created separately by a user.

That is, according to the present disclosure, a list file of a format type composed of the items of the compression object information that can be input from a user may be separately provided.

The list may be created using various codes that can express characters with a computer recognition language on a computer, but the list can express more characters, so the list may be created using ASCII code making it easy to edit compression objects on a computer.

Meanwhile, the list may further add type information input items, and may be created as a white list or a black list, depending on the purpose of a user.

Features about the white list and the black list will be described in detail below.

Next, after the list is created, the compression objects corresponding to the compression object conditions are extracted (S200).

In detail, first, an archive file for temporarily storing the compression objects is created (S210).

The archive file is a file that can integrate and store one or more data in a predetermined format.

Next, objects corresponding to the compression object conditions in the data, files, and directories (hereafter, referred to as ‘search objects’) that correspond to the search range input in the list by a user are extracted and recorded in the archive file (S240).

Copies of the extracted compression objects may be recorded in the archive file.

After the archive file is created, a process of determining whether the type information is a white list or a black list may be further performed.

When the list is a white list, objects corresponding to the compression object conditions are extracted and recorded in the archive file, as described above, and when the list is a black list, objects not corresponding to the compression object conditions are extracted and recorded in the archive file.

Accordingly, a user can perform compression while including or excluding desired backup data through the list according to the type information.

Next, when the search objects are determined as not the compression objects or are determined as the compression objects and recorded in the archive file, whether all of directories corresponding to the search range have been searched is checked (S250).

When searching all of directories corresponding to the search range is not finished, the remaining directories keep being searched until all of the directories finish being searched (S220).

Next, when all of directories corresponding to the search range finish being searched (S250), the archive file having the extracted compression objects recorded is compressed (S300).

In this case, the compressing (S300) is performed on the basis of the compression information input in the list by the user.

For example, a file having an extension according to the compression format information input in the list is created from the compressed file at the location where the user input the objects in the list.

Accordingly, the method and computer program for automatically compressing backup data on the basis of a created list of the present disclosure can manage backup data by automatically extracting and compressing compression objects on the basis of a list created by a user even though the user does not select and integrate a large amount of backup data one by one, so there is the advantage that it is possible to quickly and conveniently manage backup data without missing or repeating of data due to mistakes of a human and it is also possible to improve work efficiency.

Although the present disclosure was described above with reference to specific embodiments, the present disclosure is not limited to the embodiments and may be changed and modified in various ways by those skilled in the art without departing from the scope of the present disclosure.

The method and computer program for automatically compressing backup data on the basis of a created list of the present disclosure can be industrially used in the field of information processing industry that can perform backup by automatically extracting and compressing compression objects on the basis of a created list having property information of objects to be compressed, compression information, etc.

1. A method of automatically compressing backup data on the basis of a created list, the method comprising:
receiving property information comprising compression object conditions, of objects to be compressed and compression information from a user, and creating a list comprising the compression object conditions and the compression information;
searching for and extracting compression objects corresponding to the compression object conditions in the list; and
compressing the extracted compression objects on the basis of the compression information in the list.

2. The method of claim 1, wherein the compression object conditions include information on specific characters and/or specific extensions of the compression objects, information on a specific directory to be compressed, and information on a directory designated to search for compression objects, wherein the information on the directory designated to search is a search range for the compression objects.

3. The method of claim 2, wherein the compression information includes automatic compression period information, compressed file creation location information, and compression format information.

4. The method of claim 1, wherein the creating of the list receiving the list from a user directly in real time or a list file separately created by the user.

5. The method of claim 3, wherein the searching for and the extracting of the compression objects includes:
creating an archive file for temporarily storing the compression objects; and
extracting and recording compression objects, which correspond to the compression object conditions in a directory corresponding to the search range, in the archive file, and
wherein the compressing of the extracted compression objects comprises compressing the archive file having the compression objects recorded when all of directories corresponding to the search range finish being searched.

6. The method of claim 5, wherein the list is created by further receiving type information that can be classified as a white list and a black list, and
the searching for and the extracting the compression objects further comprises extracting and recording objects, which correspond to the compression object conditions, in the archive file when the list is the white list, and extracting and recording objects, which do not correspond to the compression object conditions, in the archive file when the list is the black list.

7. A non-transitory recording medium storing a computer program implementing the method of claim 6.
